(19) United States
(12) Patent Application Publication
(10) Pub. No.: US 2008/0280485 A1
(43) Pub. Date: Nov. 13, 2008

(54) Battery connector

(75) Inventors: Wei Yuan, ShenZhen (CN); Yu-San Hsiao, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/151,571

(22) Filed: May 7, 2008

(30) Foreign Application Priority Data
May 7, 2007 (CN) 200720037348.3

(51) Int. Cl. H01R 13/24

(52) U.S. Cl. 439/500; 439/862

(57) ABSTRACT

A battery connector comprises a terminal block and a first and second terminal received in the terminal block. The terminal block comprises a mounting face, a mating face opposite to the mounting face and a receiving cavity locating between the mounting face and the mating face. The first terminal comprises a plate-shaped base, a tail portion extending downwardly from the base, a retaining portion extending upwardly from the base and a resilient arm extending outwardly from the plane in which the base locates. The retaining portion comprises a narrowed elastic arm and a locking portion extending from the elastic arm. By this mean, the battery connector is capable of securely engaging with a coin battery.

### BACKGROUND OF THE INVENTION

1. Field of the Invention

The present invention generally relates to a battery connector, and more particularly to a connector accommodating a coin battery.

2. Description of Related Art

Coin cells or batteries are often used as back up protection for electronic equipment should there be a failure in the conventional power system. The cell has a positive electrode extending along a major surface and an edge, and a negative electrode extending over the other major surface and isolated from the positive electrode. The battery is inserted into a connector housing mountable onto a circuit board, the connector hereinafter referred to as a “battery connector”. It is desirable that a back up battery connector require a minimum amount of space on a circuit board within the equipment, be readily accessible for replacing a depleted battery.

Generally, a traditional battery connector is mounted onto a circuit board horizontally. However, this type battery connector is space consuming. Therefore a vertical type battery connector is required to meet the need. Referring to U.S. Pat. No. US 6,087,037, it discloses a general battery connector comprising a container, a first and second terminal respectively located at exterior of the container. The first terminal comprises a retaining portion, a contacting portion curved upwardly from the retaining portion and a locking portion extending upwardly from the contacting portion. The second terminal comprises a retaining portion and a contacting portion curved upwardly from the retaining portion. The first and second terminals are subject to deformation, even breaking away from the container, due to the position at where them located. In addition, the locking portion extending upwardly from the contacting portion, under this situation, the locking portion is need to be pushed outwardly when assemble or disassemble a coin battery thereby arising a permanent deformation. Therefore, this type terminal affects the reliable electrical connection.

Referring to CN patent No. 2466796Y, it discloses a battery connector having a holder and a first and second terminals received in the holder. The holder is generally of parallelepiped and rectangular shape with a pair of semicircle cutouts located at two sides thereof. The first terminal is stamped from a metal sheet and comprises a resilient contacting portion extending outwardly and a retaining portion located at right side of the contacting portion. The retaining portion is rectangular shaped thereby having a big resilient intensity. Accordingly, there is a big permanent deformation when assemble the coin battery. Furthermore, the discontinuation gap between the retaining portion and the contacting portion decreases the total intensity of the first terminal thereby affecting the reliable electrical connection.

Hence, an improved battery connector is highly desired to overcome the disadvantages of the related art.

### SUMMARY OF THE INVENTION

Accordingly, an object of the present invention is to provide a battery connector being capable of establishing a reliable electrical connection with a coin battery.

In order to achieve the object set forth, a battery connector in accordance with the present invention comprises a terminal block and a first and second terminal received in the terminal block. The terminal block comprises a mounting face, a mating face opposite to the mounting face and a receiving cavity locating between the mounting face and the mating face. The first terminal comprises a plate-shaped base, a tail portion extending downwardly from the base, a retaining portion extending upwardly from the base and a resilient arm extending outwardly from the plane in which the base locates. The retaining portion comprises a narrowed elastic arm and a locking portion extending from the elastic arm.

Other objects, advantages and novel features of the invention will become more apparent from the following detailed description when taken in conjunction with the accompanying drawings.

### BRIEF DESCRIPTION OF THE DRAWINGS

FIG. 1 is an assembled, perspective view of a battery connector in accordance with the present invention;

FIG. 2 is an exploded, perspective view of FIG. 1;

FIG. 3 is a view similar to FIG. 2, but taken from different aspect;

FIG. 4 is a perspective view of the terminal block according to the present invention;

FIG. 5 is a view similar to FIG. 4, but taken from different aspect; and

FIG. 6 is a perspective view of the first terminal with an enlarged part view according to the present invention.

### DETAILED DESCRIPTION OF THE INVENTION

Reference will now be made in detail to the preferred embodiment of the present invention.

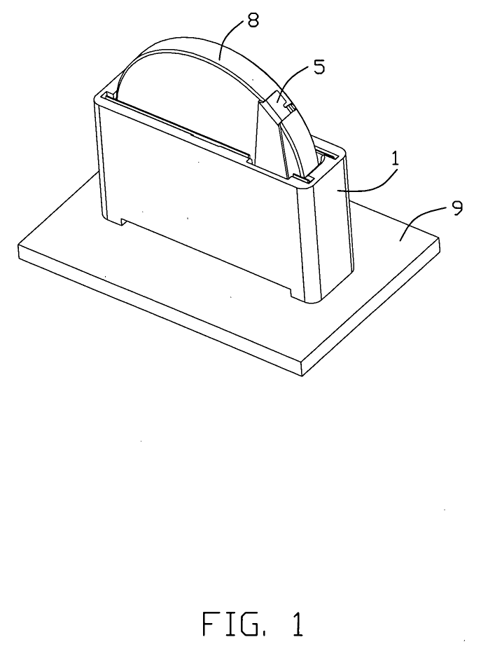

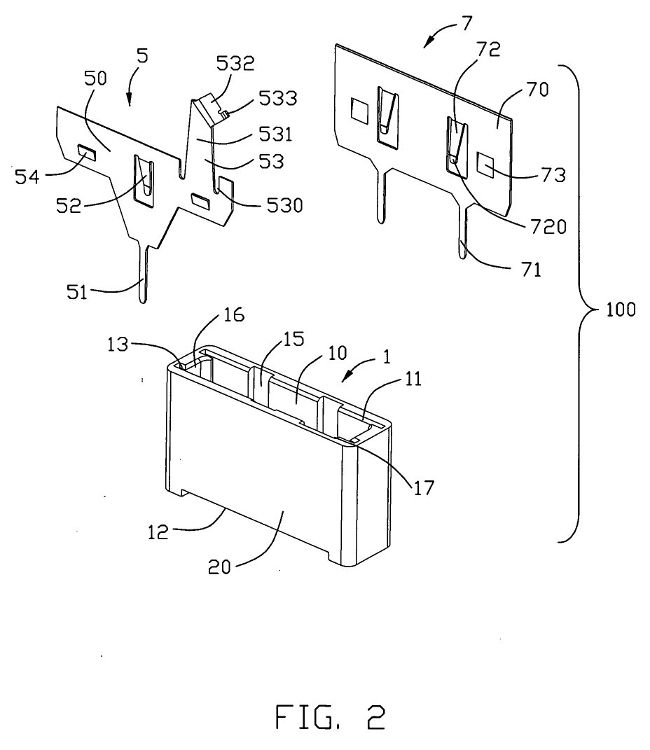

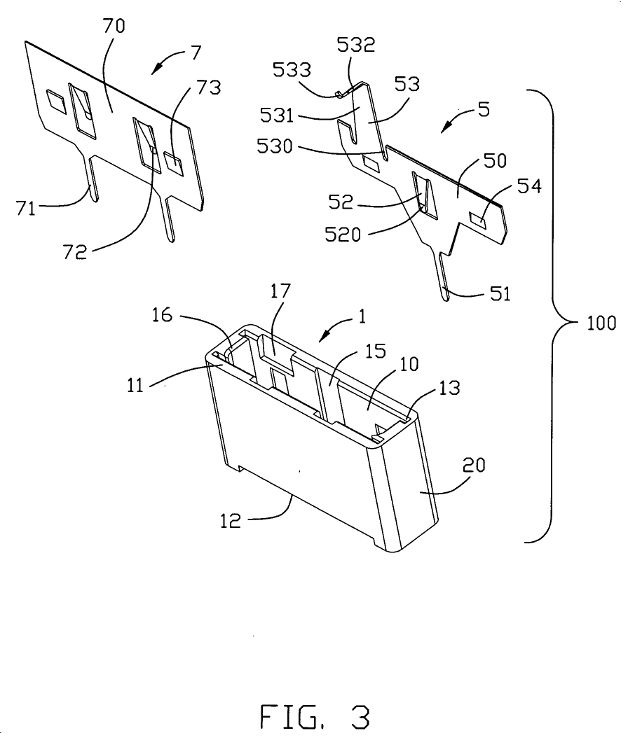

Referring to FIGS. 1-3, a battery connector 100 in accordance with the present invention adapted for mounting on a print circuit board 9, comprises a terminal block 1 and a first terminal 5 and a second terminal 7 received in the terminal block 1.

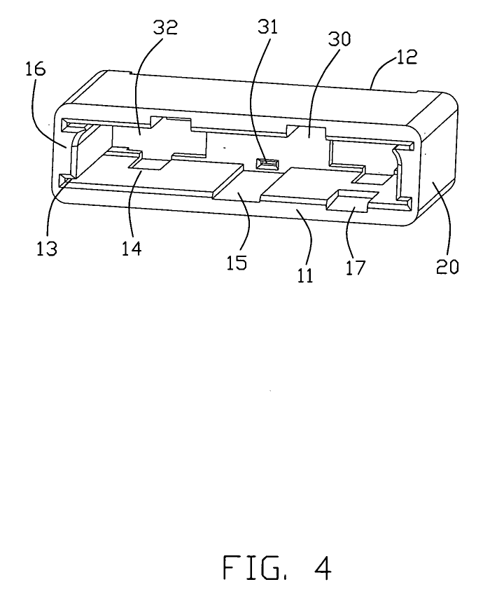

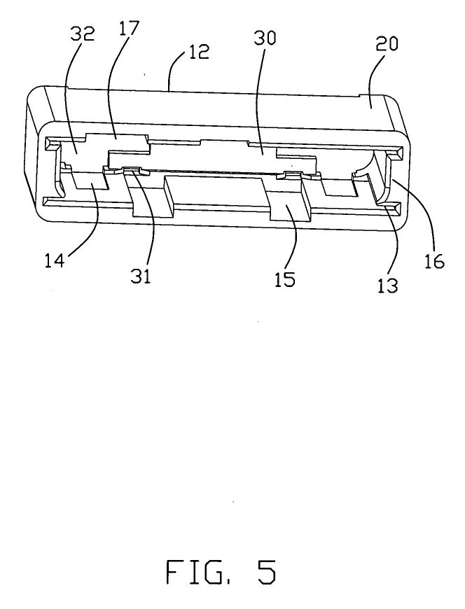

Referring to FIGS. 4-6 in conjunction with FIGS. 1-3, the terminal block 1 is of rectangular shape, and comprises parallelepiped side wall 20, a bottom wall 30 located at the bottom of the side wall 20 and a receiving cavity 10 defined by the side wall 20 and the bottom wall 30. The terminal block 1 defines a mating face 11, a mounting face 12 for engaging with the print circuit board 9 and the receiving cavity 10 arranged between the mating face 11 and the mounting face 12. The cavity 10 defines a pair of retaining slots 13 therein for receiving the first terminal 5 and the second terminal 7, a plurality of locking groove 14 recessed from the inner surface thereof, a plurality of recesses 15 depressed from the inner surface thereof, a concave 17 and a pair of guiding portions 16 protruding toward each other. Each guiding portion 16 has a arc surface for facilitating the insertion of a complementary connector in a right direction. The bottom wall 30 defines a plurality of through-holes 31 and a pair of notches 32.

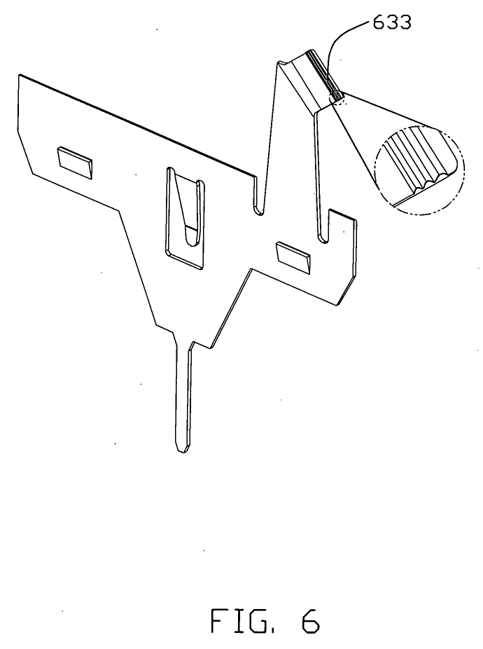

The first terminal 5 comprises a base 50, a tail portion 51 extending downwardly from the base 50, a resilient arm 52 extending slantways and downwardly from the base 50, a retaining portion 53 extending upwardly from the base 50 and a pair of locking stabs 54 locating at two sides of the resilient arm 52 and extending slantways and upwardly from the base 50. The resilient arm 52 defines a arc-shaped contacting portion 520 at the distal end thereof. The retaining portion 53 comprises a plate-shaped elastic arm 531 coplanar with the base 50 and becoming narrower and a locking tab 532 extending perpendicular to the elastic arm 531. In preferred embodiment, the retaining portion 53 locates at one side of the base 50 and the locking tab 532 is about 45 degrees relative to the horizontal plane. In an alternative embodiment, the retaining portion 53 can extends upwardly from the middle of the base 50, and accordingly, the locking tab 532 is parallel to the horizontal plane. The locking tab 532 further defines an operating portion 533 for pushing the retaining portion 53 and facilitating the assembly or disassembly the coin battery 8. In preferred embodiment, the operating portion 533 is a curved tab. Please referring to FIG. 6, the operating portion 533 can be a plurality of ribs protruding from the surface thereof. Furthermore, the base 50 defines a pair of cutouts 530 respectively adjacent to two sides of the elastic arm 531 of the retaining portion 53. The cutouts 530 is capable of increasing the relatively height of the elastic arm 531 without increasing the whole height of the first terminal 5 thereby decreasing the elastic resistance.

The second terminal 7 comprises a base plate 70, a tail portion 71 extending downwardly from the base plate 70, a pair of resilient arms 72 extending slantways and downwardly from the base plate 70 and a pair of locking stabs 74 locating at two sides of the base plate 70. The resilient arm 72 defines a arc-shaped contacting portion 720.

Referring to FIGS. 1-6, in assembly, the first terminal 5 and second terminal 7 are assemble to the receiving cavity 10 from the top of the terminal block 1 with the plurality of locking stabs 54, 73 positioned in the locking groove 14, a plurality of resilient arms 52, 72 respectively relative to the recesses 15, the tail portions 51, 71 respectively passing through the through-holes 31. The first terminal 5 locates at the side of the concave 17. The retaining portion 53 is relative to the concave 17.

In the process of usage, firstly, pushing the operating portion 533 of the retaining portion 53 outwardly to a second position. Then, the coin battery 8 is assembled into the receiving cavity 10 from the top of the terminal block 1, with the positive electrode surface and the negative electrode surface resisting against the contacting portions 520, 720 of the resilient arms 52, 72 of the first- and second terminals 5, 7. The retaining portion 53 is rebounded to retains the coin battery 8 when release the operating portion 533. Because the elastic arm 531 is relative to the concave 17, the elastic arm 531 is capable of avoiding being destroyed by directly colliding with the inner face of the side wall 20 when the resilient arm 531 moves outwardly. In addition, the plurality of resilient arms 52, 72 are respective relative to the recesses 15, therefore, the contacting portions 520, 720 of the resilient arms 52, 72 are capable of avoiding being destroyed by colliding the inner face of the side wall 20. Under the cooperation of the guiding portions 16, the resilient arms 52, 72 and the retaining portion 53, the coin battery 8 is securely retained in the receiving cavity 10 of the terminal block 1. The coin battery 8 can be extracted along a vertical direction when the operating portion 533 of the retaining portion 53 is pushed outwardly. There is no need to exert a large force to push the retaining portion 53 due to the gradually narrowed elastic arm 531. In addition, the contacting portion 520, 720 of the resilient arm 52, 72 are of arc shape to avoid scraping the surface of the coin battery 8.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A battery connector, comprising:
a terminal block having a mounting face, a mating face opposite to the mounting face and a receiving cavity locating between the mounting face and the mating face;
a first terminal and a second terminal respectively received in the terminal block, said first terminal comprising a plate-shaped base, a tail portion extending downwardly from the base and a resilient arm extending outwardly from the plane in which the base locates; and
wherein the first terminal defines a retaining portion extending upwardly from the base, said retaining portion comprises a narrowed elastic arm and a locking portion extending from the elastic arm.

2. The battery connector as claimed in claim 1, wherein the locking portion of the retaining portion further defines operating portion.

3. The battery connector as claimed in claim 2, wherein the operating portion is an operating tab curved from a distal end thereof.

4. The battery connector as claimed in claim 2, wherein the operating portion is a plurality of ribs protruding upwardly from upper face thereof.

5. The battery connector as claimed in claim 2, wherein the base of the first terminal defines a pair notches at two side thereof and adjacent to elastic arm.

6. The battery connector as claimed in claim 1, wherein the receiving cavity of the terminal block defines a concave according to the elastic arm of the retaining portion.

7. The battery connector as claimed in claim 1, wherein the second terminal defines a base plate, at least a resilient arm extending outwardly from the base plate, a pair of locking stabs located at two sides of the resilient arm and at least a tail portion extending downwardly from the base plate.

8. The battery connector as claimed in claim 7, wherein the receiving cavity of the terminal block defines a plurality of recesses according to the resilient arms of the first terminal and the second terminal.

9. The battery connector as claimed in claim 8, wherein each of the resilient arms of the first terminal and the second terminal comprises a arc-shaped contacting portion.

10. The battery connector as claimed in claim 9, wherein the first terminal further comprises a pair of locking stabs, the receiving cavity of the terminal defines a plurality of locking grooves according to the plurality of locking stabs of the first terminal and the second terminal.

11. A battery connector, comprising:
a rectangular terminal block having a continuous side wall, a bottom wall connecting with the side wall and a receiving cavity defined by the side wall and the bottom wall;
a first terminal and a second terminal respectively received in the terminal block, said first terminal comprising a plate-shaped base, a tail portion extending downwardly from the base and a resilient arm extending outwardly from the plane in which the base locates; and
wherein the first terminal defines a retaining portion extending upwardly from the base, said retaining portion comprises a narrowed elastic arm and a locking portion extending from and substantially perpendicular to the elastic arm.

12. The battery connector as claimed in claim 11, wherein the base defines a pair of notches at two side thereof and adjacent to elastic arm.

13. The battery connector as claimed in claim 12, wherein the locking portion of the retaining portion further defines operating portion.

14. The battery connector as claimed in claim 13, wherein the operating portion is an operating tab curved from a distal end thereof.

15. The battery connector as claimed in claim 13, wherein the operating portion is a plurality of ribs protruding upwardly from upper face thereof.

16. The battery connector as claimed in claim 12, wherein the second terminal defines a base plate, at least a resilient arm extending outwardly from the base plate, a pair of locking stabs located at two sides of the resilient arm and at least a tail portion extending downwardly from the base plate.

17. The battery connector as claimed in claim 12, wherein each resilient arm of the first and second terminal is all with a arc shaped contacting portion, and the receiving cavity defines a plurality of recesses according the plurality of resilient arms.

18. The battery connector as claimed in claim 11, wherein the terminal block further defines a pair of guiding portions extending from an inner surface of the side wall.

19. The battery connector as claimed in claim 18, wherein the pair of guiding portions and the side wall together define a pair of retaining slots for retaining the base of the first terminal and the base plate of the second terminal.

20. A battery connector comprising:
an insulative housing defining therein a rectangular receiving space exposed to an exterior through a mating face;
a first terminal disposed by one side of the receiving space with a first contacting finger extending into the receiving space;
a second terminal disposed by the other side of the receiving space with a second contacting finger extending into the receiving space;
at least one of said first terminal and said second terminal further including an operation arm upwardly extending beyond the mating face with a slanted pressing section essentially compliant with a contour of a battery receiving within the receiving space; wherein
said operation arm is further equipped with a handle.
